(19) United States
(12) Patent Application Publication
(10) Pub. No.: US 2011/0022492 A1
(43) Pub. Date: Jan. 27, 2011

(54) METHOD AND SYSTEM FOR SELECTING SERVICES AND/OR CONTENT IN A NETWORK COMPRISING MULTIPLE SERVICE AND/OR CONTENT PROVIDERS

(76) Inventors: Jeyhan Karaoguz, Irvine, CA (US); Bruce Currivan, Dove Canyon, CA (US); Wael Diab, San Francisco, CA (US); Yong Kim, San Jose, CA (US); Kenneth Ma, Cupertino, CA (US); Michael Johas Teener, Santa Cruz, CA (US)

Correspondence Address: MCANDREWS HELD & MALLOY, LTD, 500 WEST MADISON STREET, SUITE 3400, CHICAGO, IL, 60661, US

(21) Appl. No.: 12/571,309

(22) Filed: Sep. 30, 2009

Related U.S. Application Data
(60) Provisional application No. 61/227,668, filed on Jul. 22, 2009.

(51) Int. Cl. G06Q 30/00; G06Q 50/00

(52) U.S. Cl. 705/26.4; 705/26.3

(57) ABSTRACT

One or more processors and/or one or more circuits in a user device may be operable to communicate a request for desired content to content and service providers. Bids may be received, responsive to the request, for providing the desired content to the user device and/or other devices. The request may initiate a parallel bidding process between the content and service providers. Bids to provide and/or deliver the desired content may be received from content and/or service providers by the user device. A profile of the end user device may be configured for automatically generating the capability and/or requirements in the request, and may be stored in the end user device. The end user device may include a handheld wireless device. Delivery of the content may be at a desired price and/or at a desired time. The request for content may be submitted via a website.

### CROSS-REFERENCE TO RELATED APPLICATIONS/INCORPORATION BY REFERENCE

This application makes reference to and claims priority to, and claims the benefit of U.S. Provisional Patent Application Ser. No. 61/227,668 filed on Jul. 22, 2009.

The above stated application is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to wireless communication. More specifically, certain embodiments of the invention relate to a method and system for selecting services and/or content in a network comprising multiple service and/or content providers.

### BACKGROUND OF THE INVENTION

The growth of networking and systems' connectivity are some of the major developments in recent decades. Fewer and fewer systems and devices are operated as stand-alone entities, and most of today's systems are increasingly becoming elements in complex networks. This growth in networking allows improved performance and increased flexibility. For example, personal computers (PCs) including laptops and other specialized devices including, for example, printers, audiovisual devices and other devices, are connected together as nodes in computer networks. Networks are designated in a variety of ways, and based on a variety of factors. Network designation may be spatial, based on the scope of connectivity among the network nodes. For example, a network may be designated as a personal area network (PAN), a local area network (LAN), and wide area network (WAN). Network designation may also be based on the backbone connecting technology. For example, a network may be designated as an Ethernet network, a wireless network, and/or a fiber optical network. Some networks are circuit switched and are built around dedicated node-to-node connectivity, wherein a dedicated circuit is created and reserved, when needed, between the communicating nodes. Other nodes are then barred from utilizing the same connection and/or other entities in the network to the extent necessary to maintain the circuit. Most networks in use nowadays, however, are based on packet switched networks. In packet switched networks, the sending node simply transmits traffic that is destined for one or more receiving nodes. The traffic comprises packets that contain, in addition to data, other information that enables directing the packets to the receiving nodes. For example, most of today's networks are Internet based network and utilizes various protocols comprising TCP/IP, for example, to facilitate packet switching. In this regard, data is encapsulated into packets that comprise a header portion and a payload portion to enable transporting, addressing and/or routing among various entities within or coupled to the network.

Network switching devices, comprising such devices as switches, routers and/or hubs, are utilized in networks to facilitate forwarding of traffic between sending and receiving nodes. Hubs contain multiple ports, wherein packets arriving at one port are transmitted via all remaining ports. Consequently, hubs are generally operable to perform minimal processing. Switches also comprise multiple ports, but unlike hubs, switches are more actively functional in performing routing operations. For example, switches maintain routing information that enable the switches to examine received packets and process them accordingly to determine whether the packets are transmitted via the switch, and if so, to determine the appropriate ports to perform that transmission. Switches may store, generate, and/or maintain addressing related information of accessible network nodes.

Some network switches, however, may block traffic. Blocking occurs when a switch reaches a point where it is unable to perform additional switching even though it has not reached its theoretical maximum throughput, which generally is based on the combined maximum speeds of all of its ports.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for selecting services and/or content in a network comprising multiple service and/or content providers, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary system for selecting services and/or content, in accordance with an embodiment of the invention.

FIG. 2 is a diagram showing an exemplary user request for content, in accordance with an embodiment of the invention.

FIG. 3 is a diagram showing an exemplary multi-user request for content, in accordance with an embodiment of the invention.

FIG. 4 is a block diagram illustrating exemplary steps for selecting services and/or content in a network comprising multiple service and/or content providers, in accordance with an embodiment of the invention.

FIG. 5 is a block diagram illustrating exemplary steps for selecting services and/or content after rejection of bids from providers, in accordance with an embodiment of the invention.

### DETAILED DESCRIPTION OF THE INVENTION

Certain aspects of the invention may be found in a method and system for selecting services and/or content in a network comprising multiple service and/or content providers. In various exemplary aspects of the invention, a request for desired content may be communicated from the end user device to one or more content providers via one or more service providers. Bids may be received, responsive to the request, for providing the desired content to the user device and/or to one or more other end user devices. The request may comprise capability and/or requirements of the end user device for receiving and/or processing the requested content. The request for content may initiate a parallel bidding process between the one or more content providers and the one or more service providers. Bids may be received from the one or more content providers for the requested content and/or from the one or more service providers to deliver the requested content to the end user device. A profile of the end user device may be configured for automatically and/or manually enabling generation of the capability and/or requirements in the request, and may be stored in the end user device. The end user device may comprise a handheld wireless device. Delivery of the content may be at a desired price and/or at a desired time. The request for content may be submitted via a website.

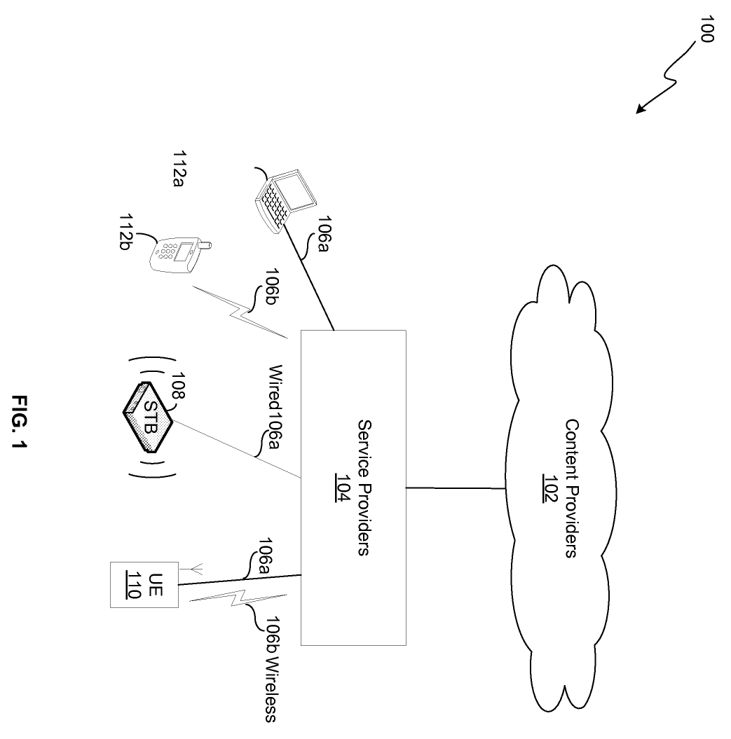

FIG. 1 is a diagram illustrating an exemplary system for selecting services and/or content, in accordance with an embodiment of the invention. Referring to FIG. 1, there is shown a communication system 100. The communication system 100 may comprise a set of content providers 102, a set of service providers 104, wired 106a and/or wireless connections 106b, and a plurality of endpoint devices, for example, a set-top box (STB) 108, user equipment (UE) 110, a laptop 112a and a cell phone 112b.

The set of content providers 102 may comprise one or more content providers. In accordance with an embodiment of the invention, a content provider may generate and/or provide a plurality of types of content, for example, audio data, video data and/or text data.

The set of service providers 104 may comprise suitable logic, circuitry, interfaces and/or code that may be operable to receive data from the set of content providers 102. The set of service providers 104 may be operable to communicate the received data to one or more endpoint devices, for example, STB 108, UE 110, laptop 112a and/or cell phone 112b. The set of service providers 104 may be operable to provide access to the Internet and/or one or more private networks via one or more of optical, wired 106a, and/or wireless connections 106b. In various embodiments of the invention, the optical, wired 106a, and/or wireless connections 106b may comprise a broadband connection such as a digital subscriber line (DSL), Ethernet, passive optical network (PON), a T1/E1 line, a cable television infrastructure, a satellite television infrastructure, and/or a satellite broadband Internet connection.

The STB 108 may comprise suitable logic, circuitry, interfaces and/or code that may be operable to connect to a display device, for example, a television set and an external source of signal from the set of service providers 104. The STB 108 may be operable to convert the received signal from the service provider to content, which may be displayed on a display device, for example, a television set. The STB 108 may be operable to provide Internet connectivity, multimedia downloads and/or IP telephony sessions.

The UE 110 may comprise suitable logic, circuitry, interfaces and/or code that may be operable to communicate utilizing one or more wired and/or wireless standards. In addition, the UE 110 may be operable to communicate with other endpoint devices, for example, laptop 112a and/or cell phone 112b, access points, and/or base stations based on one or more wireless standards such as IS-95, CDMA, EVDO, GSM, TDMA, GPRS, EDGE, UMTS/WCDMA, TD-SCDMA, HSDPA, WIMAX and/or LTE. The UE 110 may be operable to communicate based on Bluetooth, Zigbee and/or other suitable wireless technologies. Exemplary UEs 110 may comprise laptop computers, mobile phones, media players, HD television systems, video and/or still cameras, game consoles and/or location determination enabled devices. The UE 110 may be enabled to receive, process, and/or present multimedia content and may additionally be enabled to run a web browser or other applications for providing Internet services to a user of the UE 110.

In operation, the set of service providers 104 may be operable to receive content from the set of content providers 102, and communicate plurality of blocks of data to one or more endpoint devices, for example, the STB 108, UE 110, laptop 112a and/or cell phone 112b via the wired 106a and/or wireless connections 106b. At least a portion of the plurality of blocks of the data received by the STB 108, the UE 110, laptop 112a and/or cell phone 112b may be encrypted and a remaining portion of the plurality of blocks of the data may be unencrypted. The one or more endpoint devices, for example, the STB 108, the UE 110, laptop 112a and/or cell phone 112b may be operable to receive content from the set of service providers based on a particular location of the one or more endpoint devices, one or more keys corresponding to at least the portion of the plurality of blocks of the data that are encrypted. The one or more keys may be received when at least the portion of received plurality of blocks of data that are encrypted are to be rendered by one or more endpoint devices, for example, the STB 108, the UE 110, the laptop 112a and/or the cell phone 112b. The one or more endpoint devices, for example, the STB 108, the UE 110, the laptop 112a and/or the cell phone 112b may be operable to render the received plurality of blocks of the data, based on decrypting at least the portion of the plurality of blocks of the data that are encrypted utilizing the received one or more keys. The received one or more keys may be random keys generated by an encryption protocol.

In an embodiment of the invention, services may be purchased and/or subscribed to by users of the endpoint devices from the set of service providers 104 and content providers 102 by informing the providers the needs and capabilities of the end user devices. A bidding process may be utilized in the network of providers, where the network enables the resolution of the bidding process by communicating the service and cost options to the user either from the set of content providers 102 or service providers 104. The bidding may be managed by either the set of content providers 102 or the set of service providers 104, both providers, or with the set of content providers 102 as an intermediary.

In an embodiment of the invention, a consumer may indicate how much they are willing to pay for particular content or services, and may enter a bid through their user equipment, such as the STB 108, the UE 110, the laptop 112a and/or the cell phone 112b. The bid may comprise a specific cost or a desirable price range. The request may include a preferred content delivery time and/or the destination user equipment.

The content providers 102 and the service providers 104 may submit bids that may be communicated to the user so that the user may select or reject bids. If a bid is acceptable, the user may accept, pay for, and download the desired content and/or services. A bid may be accepted from both a content provider and a service provider, or a bid from an intermediary, such as a content provider that arranges for content delivery via a preferred service provider. In another embodiment of the invention, a service provider may act as a intermediary that arranges for desired content from content providers, submitting a single bid to the user for both the content itself and the delivery of the desired content. In instances wherein none of the bids are acceptable to the user, the user may submit a counteroffer, after which the content providers 102 and/or the service providers 104 may submit secondary bids to the user.

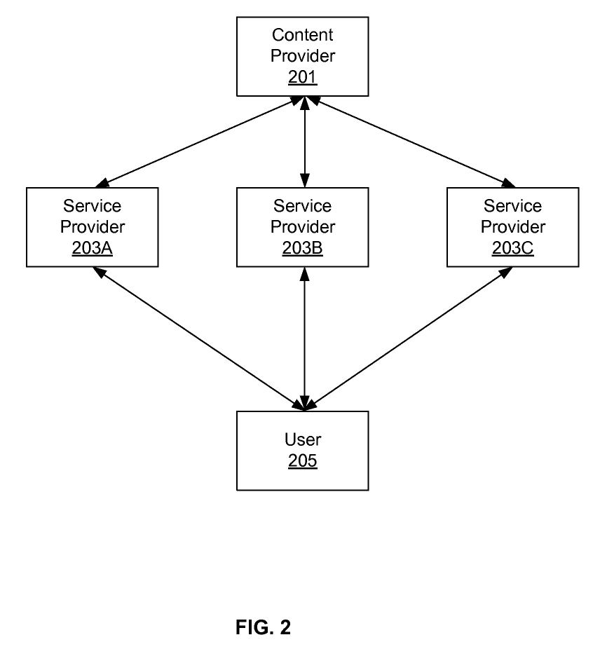

FIG. 2 is a diagram showing an exemplary user request for content, in accordance with an embodiment of the invention. Referring to FIG. 2, there is shown a content provider 201, service providers 203A-203C, and a user device 205. The content provider 201 and the service providers 203A-203C may be substantially similar to the set of content providers 102 and the set of service providers 104 described with respect to FIG. 1. The user device 205 may comprise user equipment, such as the STB 108, the UE 110, the laptop 112a and/or the cell phone 112b, for example, also described with respect to FIG. 1.

In operation, services may be purchased by the user device 205 from the service providers 203A-203C and the content provider 201 by informing the providers the needs and capabilities of the user device 205. A bidding process may be utilized in the network of providers, where the network enables the resolution of the bidding process by communicating the service and cost options to the user either from the content provider 201 or the service providers 203A-203C. The bidding may be managed by either the content providers 201 or the service providers 203A-203C, both providers, or with the content provider 201 as an intermediary.

The user device 205 may transmit a request to the service providers 203A-203C for desired content, which may be obtained from the content provider 201. The request may comprise the desired cost and a profile of the capability of the user's device, such as the data format, type of user device, resolution, and bandwidth, for example. In one embodiment of the invention, the user profile may comprise capabilities for a plurality of user devices that may be utilized by a particular user. Accordingly, depending on which of the plurality of devices a user may utilize to render the data, corresponding capabilities of that user device may be communicated to the content provider 201 and/or the service providers 203A-203C. The generation of a profile of the user's device may enable automatic communication of capability and requirements in the requests, and may be stored in the user device 205. One or more of the service providers 203A-203C may relay the information to the content provider 201, which may respond with its bid to the user device 205 via the one or more service providers 203A-203C. The user device 205 may select, or deny, the bid from the content provider 201, sending a request for the content back to the content provider 201.

If a bid is acceptable, the user may accept, pay for, and download the desired content and/or services. A bid may be accepted from both a content provider and a service provider, or a bid from an intermediary, such as a content provider that arranges for content delivery via a preferred service provider. The user may submit a counteroffer to the lowest bidder or all of the bidders, if none of the bids are acceptable, after which the content provider 102 and/or the service providers 104 may submit secondary bids to the user. If one or more secondary bids are acceptable to the user, the user device 205 may communicate an acceptance and arrange for payment for the content and/or services to be provided by the content and service providers.

Each of the service providers 203A-203C may bid for all or part of the delivery of a user's request, delivering the content from the content provider 201. Each of the provider entities may receive the user's profile from the user's request, which may comprise a standardized profile format for uniformity between users and content/service providers.

In another embodiment of the invention, the user device 205 may be operable to perform a service interval or network availability scan, such that the user device 205 may determine a future time that may be appropriate for delivery of content via one or more service providers. For example, the content provider 201 and/or the service providers 203A-203C may broadcast or advertise their capabilities such that the user device 205 may learn during a network availability scan when content may be provided in the future.

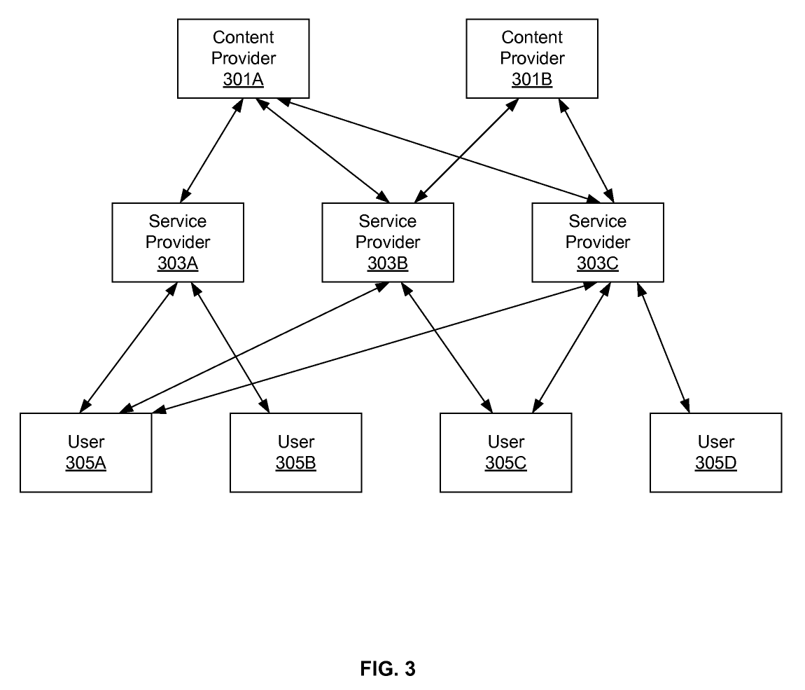

FIG. 3 is a diagram showing an exemplary multi-user request for content, in accordance with an embodiment of the invention. Referring to FIG. 3, there is shown content providers 301A and 301B, service providers 303A-303C, and user devices 305A-305D. The content providers 301A and 301B, the service providers 303A-303C, and the user devices 305A-305D may be substantially similar to the content provider 201, the service providers 203A-203C, and the user device 205, respectively, described with respect to FIG. 2.

In operation, services may be purchased by the user devices 305A-305D from the service providers 303A-330C and the content providers 301A and 301B by informing the providers the needs and capabilities of the user devices 305A-305D. A bidding process may be utilized in the network of providers, where the network enables the resolution of the bidding process by communicating the service and cost options to the user either from the content providers 301A and 301B and/or the service providers 303A-303C. The bidding may be managed by either the content providers 301A and 301B or the service providers 303A-303C, both types of providers, or with the content providers 301 as intermediaries. A bid may be accepted from both a content provider and a service provider, or a bid from an intermediary, such as a content provider that arranges for content delivery via a preferred service provider. An intermediary may interact directly with users on behalf of one or more other providers, including content and service providers, for example.

The user devices 305A-305D may transmit requests to the service providers 303A-303C for desired content, which may be obtained from the content providers 301A and 301B. The request may comprise the desired cost or a range of cost and a profile of the capability of the user's device, such as the data format, resolution, and bandwidth, for example. In another embodiment of the invention, the user devices 305A-305D may enter a bid request from a website. One or more of the service providers 303A-303C may relay the information to the content provider 301A and/or 301B, which may respond with a bid to the user devices 305A-305D via the one or more service providers 303A-303C. The user devices 305A-305D may be operable to select, or deny, the bid from the content providers 301A and/or 301B, sending a request for the content back to the content providers 301A and/or 301B.

Each of the service providers 303A-303C may bid for all or part of the delivery of a user's request, delivering the content from the content providers 301A and/or 301B. Each of the provider entities may receive the user's profile from the user's request, which may comprise a standardized profile format for uniformity between users and content/service providers. The bidding process may operate as a simultaneous parallel process with requests sent to multiple service and content providers.

In another embodiment of the invention, the user device 205 may be operable to perform a service interval or network availability scan, such that the user devices 305A-305D may determine a future time that may be appropriate for delivery of content via one or more service providers 303A-303C. For example, the content providers 301A and 301B and/or the service providers 303A-303C may broadcast or advertise their capabilities such that the user devices 305A-305D may learn during a network availability scan when content may be provided in the future.

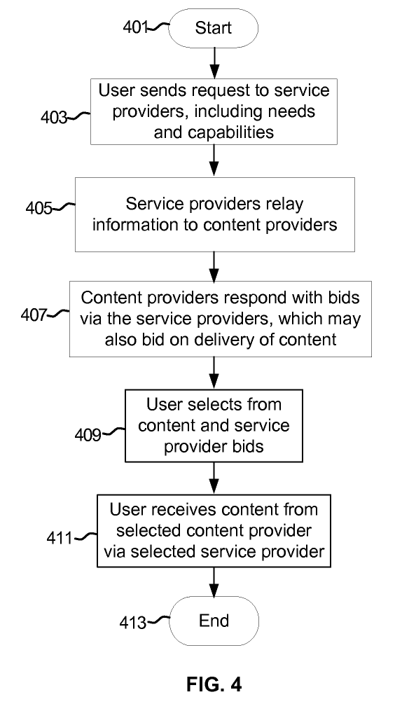

FIG. 4 is a block diagram illustrating exemplary steps for selecting services and/or content in a network comprising multiple service and/or content providers, in accordance with an embodiment of the invention. Referring to FIG. 4, in step 403 after start step 401, one or more users may send a bid request for content. The request may also comprise needs and capability information of the users. In step 405, the service providers may forward the request to content providers, followed by step 407, where the content providers may respond with bids via the service providers, which may also submit bids for delivering the requested content. In step 409, the users may select from the received content and service provider bids. In step 411, the users may receive content from selected content providers via selected service providers, before proceeding to end step 413.

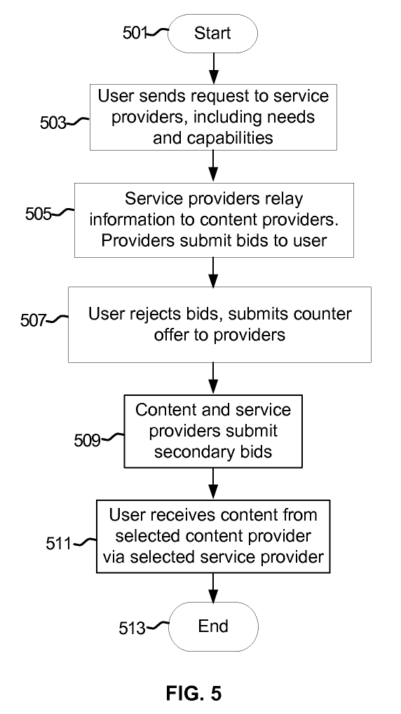

FIG. 5 is a block diagram illustrating exemplary steps for selecting services and/or content after rejection of bids from providers, in accordance with an embodiment of the invention. Referring to FIG. 5, in step 503 after start step 501, one or more users may send a bid request for content. The request may also comprise needs and capability information of the users. In step 505, the service providers may forward the request to content providers, and the content and service providers may submit bids to the user, followed by step 507, where the user may reject the received bids. In step 509, the content and service providers may submit secondary bids. In step 511, the users may receive content from selected content providers via selected service providers, before proceeding to end step 513.

In an embodiment of the invention, a method and system are disclosed to select services and/or content in a network comprising multiple service and/or content providers. In this regard, a request for desired content may be communicated from the end user device to one or more content providers via one or more service providers. Bids may be received, responsive to the request, for providing the desired content to the user device and/or to one or more other end user devices. Services and/or content may be selected in a network comprising multiple service and/or content providers. A request for content from the user devices 108, 110, 112a, 112b, 205, 305A-305D may be communicated to one or more content providers 102, 201, 301A, 301B via one or more service providers 104, 203A-203C, 303A-303C. The request may comprise capability and/or requirements of the user devices 108, 110, 112a, 112b, 205, 305A-305D for receiving and/or processing the requested content. The request for content may initiate a parallel bidding process between the one or more content providers 102, 201, 301A, 301B and the one or more service providers 104, 203A-203C, 303A-303C. Bids may be received from the one or more content providers 102, 201, 301A, 301B for the requested content and/or from the one or more service providers 104, 203A-203C, 303A-303C to deliver the requested content to the user devices 108, 110, 112a, 112b, 205, 305A-305D. A profile of the user devices 108, 110, 112a, 112b, 205, 305A-305D may be configured for automatically generating the capability and/or requirements in the request, and may be stored in the user devices 108, 110, 112a, 112b, 205, 305A-305D. The user devices 108, 110, 112a, 112b, 205, 305A-305D may comprise one or more of: handheld wireless device, set-top box, laptop computer, and/or desktop computer. Delivery of the content may be at a desired price and/or at a desired time. The request for content may be submitted via a website.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for selecting services and/or content in a network comprising multiple service and/or content providers.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for communication, the method comprising:
performing by one or more processors and/or circuits in an end user device:
communicating a request for desired content from said end user device to one or more content providers via one or more service providers; and
responsive to said request, receiving bids for providing said desired content to said user device and/or to one or more other end user devices.

2. The method according to claim 1, wherein said request for said desired content initiates a parallel bidding process between said one or more content providers and/or said one or more service providers.

3. The method according to claim 1, wherein said request comprises capability and/or requirements of said end user device, and/or said one or more other end user devices, for receiving and/or processing said desired content.

4. The method according to claim 1, comprising receiving bids from said one or more service providers to deliver said desired content to said end user device.

5. The method according to claim 1, comprising configuring said end user device to automatically generate said capability and/or requirements in said request based on a profile.

6. The method according to claim 5, comprising storing said profile in said end user device.

7. The method according to claim 1, wherein said end user device comprises one or more of: handheld wireless device, set-top box, laptop computer, and/or desktop computer.

8. The method according to claim 1, comprising requesting delivery of said desired content at a specified price or a price range.

9. The method according to claim 1, comprising specifying in said request delivery of said desired content at a desired time.

10. The method according to claim 1, comprising submitting said request for said desired content via a website.

11. A system for communication, the system comprising:
one or more processors and/or circuits in a plurality of networked devices, said one or more processors and/or circuits are operable to:
communicate a request for desired content from said end user device to one or more content providers via one or more service providers; and
responsive to said request, receive bids for providing said desired content to said user device and/or to one or more other end user devices.

12. The system according to claim 11, wherein said request for said desired content initiates a parallel bidding process between said one or more content providers and/or said one or more service providers.

13. The system according to claim 11, wherein said request comprises capability and/or requirements of said end user device, and/or said one or more other end user devices, for receiving and/or processing said desired content.

14. The system according to claim 11, wherein said one or more processors and/or circuits are operable to receive bids from said one or more service providers to deliver said desired content to said end user device.

15. The system according to claim 11, wherein said one or more processors and/or circuits are operable to automatically generate said capability and/or requirements in said request based on a profile.

16. The system according to claim 15, wherein said one or more processors and/or circuits are operable to store said profile in said end user device.

17. The system according to claim 11, wherein said end user device comprises one or more of: handheld wireless device, set-top box, laptop computer, and/or desktop computer.

18. The system according to claim 11, wherein said one or more processors and/or circuits are operable to request delivery of said desired content at a specified price or a price range.

19. The system according to claim 11, wherein said one or more processors and/or circuits are operable to specify in said request for delivery of said desired content at a desired time.

20. The system according to claim 11, wherein said one or more processors and/or circuits are operable to submit said request for said desired content via a website.
